(19) United States
(12) Patent Application Publication
(10) Pub. No.: US 2026/0127398 A1
(43) Pub. Date: May 7, 2026

(54) HYBRID IDENTIFICATION DEVICE AND USE METHOD THEREOF

(71) Applicant: Gingy Technology Inc., Hsinchu City (TW)

(72) Inventors: Chih-Hao Wang, Hsinchu City (TW); Mon-Nan Ho, Hsinchu City (TW); Ping-Chen Chen, Hsinchu City (TW); Yu-Ling Hsu, Hsinchu City (TW); Jung-Fen Chang, Hsinchu City (TW); Yuan-Che Lo, Hsinchu City (TW)

(73) Assignee: Gingy Technology Inc., Hsinchu City (TW)

(21) Appl. No.: 19/379,771

(22) Filed: Nov. 5, 2025

Related U.S. Application Data
(60) Provisional application No. 63/716,735, filed on Nov. 6, 2024.

(51) Int. Cl. G06K 7/14; G06K 19/06

(52) U.S. Cl. CPC G06K 7/1417; G06K 19/06037

(57) ABSTRACT

A hybrid identification device and a method of operating the same are provided. The device includes a first identification module configured to extract biometric features to generate a biometric feature signal, a second identification module configured to extract graphic features to generate a graphic feature signal, and a processing unit electrically connected to both identification modules. The processing unit identifies the biometric features and/or the graphic features based on the respective signals to generate a processing signal.

### CROSS-REFERENCE TO RELATED APPLICATION

This application claims the priority benefit of U.S. provisional application Ser. No. 63/716,735, filed on Nov. 6, 2024. The entirety of the above-mentioned patent application is hereby incorporated by reference herein and made a part of this specification.

### BACKGROUND

### Technical Field

This disclosure relates to an extraction device, and particularly relates to a hybrid identification device.

### Description of Related Art

Currently, existing biometric identification is interfered with under special environments, or identification features are damaged and cannot be correctly read, resulting in identification failure and inability to unlock. In situations involving visitors, maintenance, and sharing, temporary user biometric features need to be registered, which creates personal data and management issues. Traditional biometric identification lacks flexible backup solutions, and currently requires additional components and costs to solve, unable to meet actual usage requirements.

### SUMMARY

The disclosure provides a hybrid identification device and a use method thereof, which may enhance system security and user experience, and through simple software and hardware combination, realizes low-cost and high-efficiency technology application, creating new possibilities for future identity verification technology.

The disclosure provides a hybrid identification device, including a first identification module, a second identification module, and a processing unit. The first identification module is configured to extract biometric features to generate a biometric feature signal. The second identification module is configured to extract graphic features to generate a graphic feature signal. The processing unit is electrically connected to the first identification module and the second identification module, configured to identify the biometric features according to the biometric feature signal and/or configured to identify the graphic features according to the graphic feature signal, thereby generating a processing signal.

Based on the above, in the hybrid identification device and the use method thereof of the disclosure, the hybrid identification device includes a first identification module, a second identification module, and a processing unit. The first identification module is used to extract biometric features to generate a biometric feature signal, the second identification module is used to extract graphic features to generate a graphic feature signal, and the processing unit is used to identify biometric features according to the biometric feature signal and/or used to identify graphic features according to the graphic feature signal, thereby generating a processing signal. In this way, unlocking or executing subsequent processes may be achieved by one of the biometric features and graphic features, thereby providing users with diversified password or privacy unlock choices, avoiding inability to unlock due to identification failure, enhancing system security and user experience, and realizing low-cost and efficient technology application through simple hardware and software combination, creating new possibilities for future identity verification technology. In addition, the purpose of hybrid identification may be achieved by the same device, which may further save hardware cost while providing multi-level identity verification, capable of addressing usage challenges in different environments.

Other objectives, features and advantages of the disclosure will be further understood from the further technological features disclosed by the embodiments of the disclosure wherein there are shown and described preferred embodiments of this invention, simply by way of illustration of modes best suited to carry out the invention.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention.

FIG. 1 is a schematic diagram of a hybrid identification device identifying an object to be identified according to an embodiment of the disclosure.

FIG. 2 is a schematic diagram of a hybrid identification device identifying an object to be identified according to another embodiment of the disclosure.

FIG. 3A to FIG. 3D are schematic diagrams of objects to be identified according to different embodiments of the disclosure, respectively.

FIG. 4A to FIG. 4C are schematic diagrams of objects to be identified according to different embodiments of the disclosure, respectively.

FIG. 5A to FIG. 5E are schematic diagrams of an object to be identified providing different graphic feature signals according to an embodiment of the disclosure, respectively.

FIG. 6 is a flowchart of a use method of a hybrid identification device according to an embodiment of the disclosure.

### DESCRIPTION OF THE EMBODIMENTS

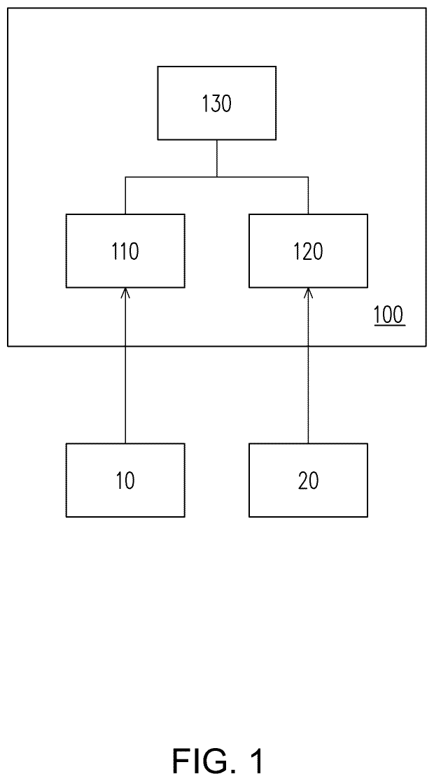

FIG. 1 is a schematic diagram of a hybrid identification device identifying an object to be identified according to an embodiment of the disclosure. Please refer to FIG. 1. This embodiment provides a hybrid identification device 100 for identifying objects 10, 20 containing biometric features and/or graphic features, and then performing password or privacy unlocking. The biometric features include, for example, at least one of a user's fingerprint, face, vein, iris, palm shape, and body shape, while the graphic features include, for example, at least one of geometric patterns, two-dimensional barcodes, three-dimensional patterns, pattern light sources, and image screens. For example, in this embodiment, the object 10 is a user having biometric features, while the object 20 is a static/dynamic planar/three-dimensional image or video having graphic features. In other words, the geometric patterns, two-dimensional barcodes, three-dimensional patterns, and/or pattern light sources are formed on physical objects, but the disclosure is not limited thereto.

In this embodiment, the hybrid identification device 100 includes a first identification module 110, a second identification module 120, and a processing unit 130. The first identification module 110 is, for example, at least one of an optical sensor, a capacitive sensor, an ultrasonic identifier, and a time-of-flight sensor, for extracting biometric features to generate biometric feature signals. The second identification module 120 is, for example, an imaging element, for extracting graphic features to generate graphic feature signals. In different embodiments, the first identification module 110 and the second identification module 120 may share at least a portion of components, and the disclosure is not limited thereto.

The processing unit 130 is electrically connected to the first identification module 110 and the second identification module 120, for generating processing signals according to the biometric feature signals or graphic feature signals generated by the first identification module 110 or the second identification module 120. The processing unit 130 is, for example, a Central Processing Unit (CPU), or other programmable general-purpose or special-purpose Microprocessor, Digital Signal Processor (DSP), programmable controller, Application Specific Integrated Circuit (ASIC), or other similar components or combinations of the aforementioned components, and the disclosure is not limited thereto.

In this way, unlocking or executing subsequent processes may be achieved by one of biometric features and graphic features, thereby providing users with diversified password or privacy unlock choices, avoiding inability to unlock due to identification failure, enhancing system security and user experience, and realizing low-cost and efficient technology applications through simple combination of software and hardware, creating new possibilities for future identity verification technology. In addition, the purpose of hybrid identification may be achieved by the same device, which may further save hardware costs while providing multi-level identity verification, capable of addressing usage challenges in different environments.

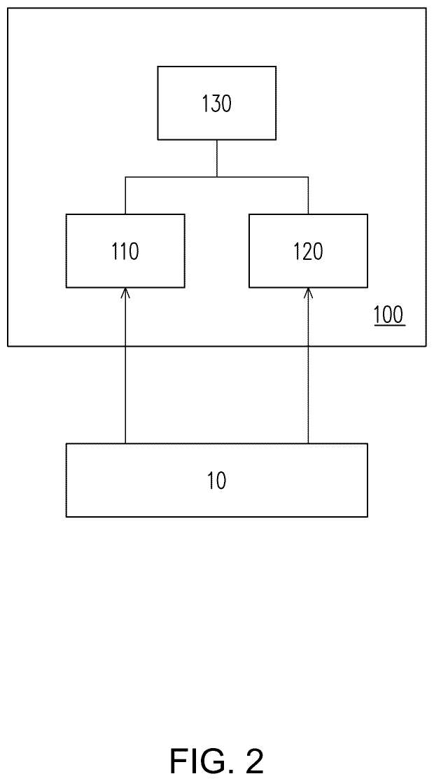

FIG. 2 is a schematic diagram of a hybrid identification device identifying an object to be identified according to another embodiment of the disclosure. Please refer to FIG. 2. The hybrid identification device 100 shown in this embodiment is the same as the hybrid identification device 100 shown in FIG. 1, and the difference between them is that in this embodiment, the object 10 carries biometric features and graphic features. Therefore, the hybrid identification device 100 may simultaneously extract biometric features and graphic features from the object 10 to respectively generate biometric feature signals and graphic feature signals. The processing unit 130 generates processing signals according to the biometric feature signals or graphic feature signals generated by the first identification module 110 and the second identification module 120. In this way, unlocking or executing subsequent processes may be achieved by one of biometric features and graphic features, thereby providing users with diversified password or privacy unlock choices, avoiding inability to unlock due to identification failure, and enhancing security and convenience. In addition, the purpose of hybrid identification may be achieved by the same device, which may further save hardware costs.

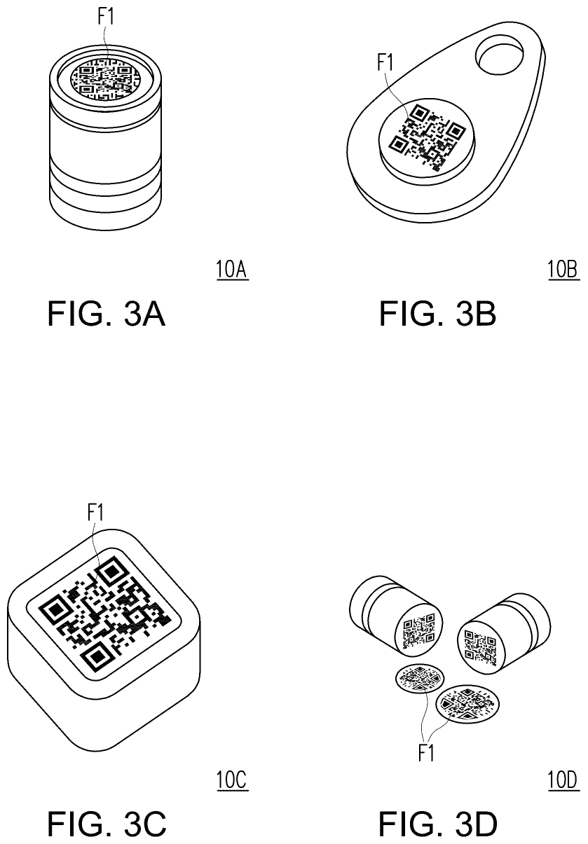

FIG. 3A to FIG. 3D are schematic diagrams of objects to be identified according to different embodiments of the disclosure, respectively. Please refer to FIG. 3A to FIG. 3D. It should be noted that in any embodiment, objects 10A, 10B, 10C, 10D carrying graphic features F1 may be, for example, key chains with two-dimensional barcodes, stamps, or handheld lights capable of projecting two-dimensional barcodes, as shown in FIG. 3A to FIG. 3D, and the disclosure is not limited thereto.

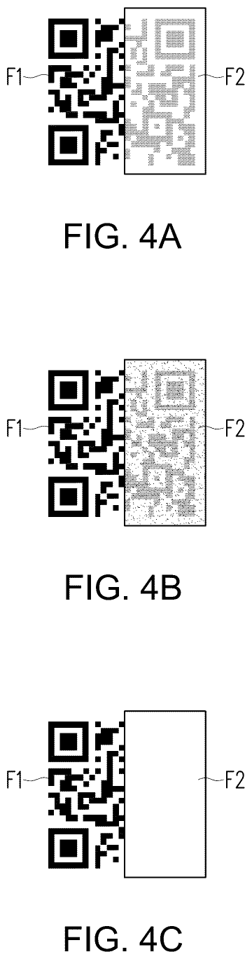

FIG. 4A to FIG. 4C are schematic diagrams of objects to be identified according to different embodiments of the disclosure, respectively. Please refer to FIG. 4A to FIG. 4C. In other embodiments, the second identification module 20 (or the first identification module 10) is further used to extract anti-peeping feature F2 to generate anti-peeping feature signals, and the anti-peeping feature F2 covers and overlaps at least a portion of the graphic features F1. For example, in one embodiment, the anti-peeping feature F2 is, for example, light filtering patterns, which require identification by special wavelengths to identify the portion of the graphic features F1 covered and overlapped by the anti-peeping feature F2, as shown in FIG. 4A. In another embodiment, the anti-peeping feature F2 is, for example, defocused patterns, which require identification by focusing to identify the portion of the graphic features F1 covered and overlapped by the anti-peeping feature F2, as shown in FIG. 4B. In another embodiment, the anti-peeping feature F2 is, for example, polarized patterns, which require identification by adding polarization effects to identify the portion of the graphic features F1 covered and overlapped by the anti-peeping feature F2, as shown in FIG. 4C. In this way, the anti-peeping effect of the graphic features F1 may be further enhanced, thereby further improving information security.

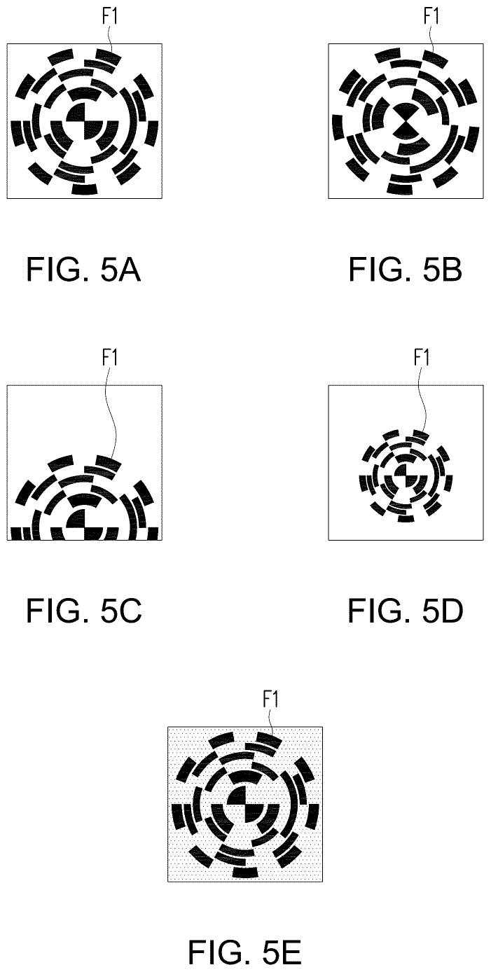

FIG. 5A to FIG. 5E are schematic diagrams of an object to be identified providing different graphic feature signals according to an embodiment of the disclosure, respectively. Please refer to FIG. 5A to FIG. 5C. In some embodiments, the processing unit 130 further modifies the processing signal according to changes in the graphic feature signal. The changes in the graphic feature signal include rotation of the graphic feature signal, position change, scaling, and wavelength change. For example, when the graphic feature F1 is in a normal state, it may proceed to start a motorcycle, as shown in FIG. 5A. When the graphic feature F1 is rotated, moved, scaled, or displayed in reverse, it may proceed to additional functions of the motorcycle, such as opening the fuel tank cap or turning off the engine, as shown in FIG. 5B to FIG. 5E, but the disclosure is not limited thereto. In this way, the component having the graphic feature F1 may not only serve as a key, but may also be identified by the identification module to provide various different operational behaviors, thereby further enhancing convenience and interactivity.

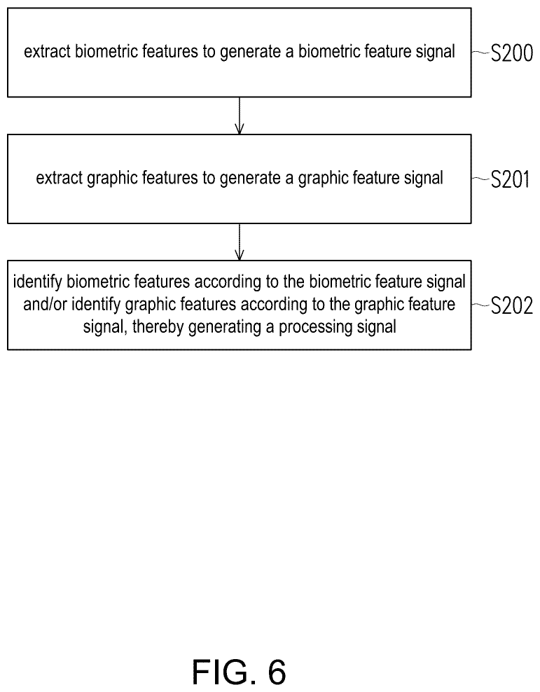

FIG. 6 is a flowchart of a use method of a hybrid identification device according to an embodiment of the disclosure. Please refer to FIG. 1, FIG. 2, and FIG. 6. The use method of the hybrid identification device of this embodiment may at least be applied to the hybrid identification device 100 of FIG. 1 or FIG. 2, so the following description uses this as an example. First, step S200 is executed to extract biometric features to generate a biometric feature signal. Specifically, in this embodiment, the first identification module 110 extracts the object 10 having biometric features to generate a biometric feature signal and transmit it to the processing unit 130. Next, step S201 is executed to extract graphic features to generate a graphic feature signal. Specifically, in this embodiment, the second identification module 120 extracts the object 20 having graphic features to generate a graphic feature signal and transmit it to the processing unit 130. Finally, step S202 is executed to identify biometric features according to the biometric feature signal and/or identify graphic features according to the graphic feature signal, thereby generating a processing signal. Specifically, in this embodiment, the processing unit 130 generates a processing signal according to the biometric feature signal or graphic feature signal generated by the first identification module 110 or the second identification module 120. In this way, unlocking or executing subsequent processes may be achieved by one of the biometric features and graphic features, thereby providing users with diversified password or privacy unlock choices, avoiding inability to unlock due to identification failure, enhancing system security and user experience, and realizing low-cost and efficient technology application through simple hardware and software combination, creating new possibilities for future identity verification technology. In addition, the purpose of hybrid identification may be achieved by the same device, which may further save hardware cost while providing multi-level identity verification, capable of addressing usage challenges in different environments.

In summary, in the hybrid identification device and the use method thereof of the disclosure, the hybrid identification device includes a first identification module, a second identification module, and a processing unit. The first identification module is used to extract biometric features to generate a biometric feature signal, the second identification module is used to extract graphic features to generate a graphic feature signal, and the processing unit is used to identify biometric features according to the biometric feature signal and/or used to identify graphic features according to the graphic feature signal, thereby generating a processing signal. In this way, unlocking or executing subsequent processes may be achieved by one of the biometric features and graphic features, thereby providing users with diversified password or privacy unlock choices, avoiding inability to unlock due to identification failure, enhancing system security and user experience, and realizing low-cost and efficient technology application through simple hardware and software combination, creating new possibilities for future identity verification technology. In addition, the purpose of hybrid identification may be achieved by the same device, which may further save hardware cost while providing multi-level identity verification, capable of addressing usage challenges in different environments.

It will be apparent to those skilled in the art that various modifications and variations can be made to the disclosed embodiments without departing from the scope or spirit of the disclosure. In view of the foregoing, it is intended that the disclosure covers modifications and variations provided that they fall within the scope of the following claims and their equivalents.

What is claimed is:

1. A hybrid identification device, comprising:
a first identification module, configured to extract biometric features to generate a biometric feature signal;
a second identification module, configured to extract graphic features to generate a graphic feature signal; and
a processing unit, electrically connected to the first identification module and the second identification module, configured to identify the biometric features according to the biometric feature signal and/or configured to identify the graphic features according to the graphic feature signal, thereby generating a processing signal.

2. The hybrid identification device according to claim 1, wherein the first identification module comprises at least one of an optical sensor, a capacitive sensor, an ultrasonic identifier, and a time-of-flight sensor.

3. The hybrid identification device according to claim 1, wherein the biometric features comprise at least one of a user's fingerprint, face, vein, iris, palm shape, and body shape.

4. The hybrid identification device according to claim 1, wherein the second identification module comprises a camera element.

5. The hybrid identification device according to claim 1, wherein the graphic features comprise at least one of geometric patterns, two-dimensional barcodes, three-dimensional patterns, pattern light sources, and image screens.

6. The hybrid identification device according to claim 5, wherein the geometric patterns, the two-dimensional barcodes, the three-dimensional patterns, and/or the pattern light sources are formed on a physical object.

7. The hybrid identification device according to claim 1, wherein the processing unit further modifies the processing signal according to changes in the graphic feature signal.

8. The hybrid identification device according to claim 7, wherein the changes in the graphic feature signal comprise rotation of the graphic feature signal, position change, scaling, and wavelength change.

9. The hybrid identification device according to claim 1, wherein the second identification module is further configured to extract anti-peeping features to generate an anti-peeping feature signal, and the anti-peeping features cover and overlap at least a portion of the graphic features.

10. The hybrid identification device according to claim 9, wherein the anti-peeping feature signal comprises at least one of patterns with different wavelengths from the graphic feature signal, defocused patterns, and polarized patterns.

11. A use method of a hybrid identification device, comprising:
extracting biometric features to generate a biometric feature signal;
extracting graphic features to generate a graphic feature signal; and
identifying the biometric features according to the biometric feature signal and/or identifying the graphic features according to the graphic feature signal, thereby generating a processing signal.

12. The use method of a hybrid identification device according to claim 11, further comprising:
modifying the processing signal according to changes in the graphic feature signal.

13. The use method of a hybrid identification device according to claim 11, wherein the method of extracting the graphic features to generate the graphic feature signal further comprises:
extracting anti-peeping features to generate an anti-peeping feature signal; and
generating the graphic feature signal according to the anti-peeping feature signal and the graphic features.
